(19) United States
(12) Patent Application Publication
(10) Pub. No.: US 2011/0147136 A1
(43) Pub. Date: Jun. 23, 2011

(54) ELEVATOR MONITORING SYSTEM

(75) Inventor: Shinichi Kuroda, Tokyo (JP)

(73) Assignee: MITSUBISHI ELECTRIC CORPORATION, TOKYO (JP)

(21) Appl. No.: 13/059,299

(22) PCT Filed: Oct. 17, 2008
(86) PCT No.: PCT/JP08/68856

§ 371 Date: Feb. 16, 2011

(51) Int. Cl. B66B 3/02

(52) U.S. Cl. 187/394

(57) ABSTRACT

Provided is an elevator monitoring system capable of preventing the indication of car positions from becoming discontinuous on a monitoring screen in the event of an accident. For this purpose, the elevator monitoring system is provided with a car-position information search device which detects a car-position floor of an elevator, an indication device which indicates a symbol indicative of the car-position floor and a symbol indicative of the car so as to correspond to each other, a speed calculating device which calculates the speed of the car on the basis of a distance corresponding to a change in the car-position floor and the time required by the change, an indication unit determining device which increases the number of stories as a unit in the indication unit of the symbol indicative of the car-position floor in the case of an increase in the speed of the car, and an indication controller which causes the indication device to indicate the symbol indicative of the car-position floor by an indication unit determined by the indication unit determining device.

### TECHNICAL FIELD

The present invention relates to an elevator monitoring system in which an indication device is caused to indicate elevator car-position floors.

### BACKGROUND ART

In general, the update cycle of an elevator monitoring screen is determined on the basis of the time for creating data to be indicated on a monitoring screen, the time required by an indication, and the waiting time for accepting a user operation. When this update cycle is shorter than the receiving cycle of elevator status data, an elevator monitoring system can continuously indicate elevator status data.

In recent years, with the construction of increasingly higher rise buildings, also the speed of elevators has been increasing. That is, with the speed of elevators becoming higher, the floor information of elevators has changed in increasingly short intervals. Therefore, it is necessary to shorten the update cycle of an elevator monitoring screen in order to continuously indicate the elevator status data on the monitoring screen.

There has been proposed an elevator monitoring system which has means for indicating car parts on the screen of an indication device in synchronization with the operation of an elevator, means of analog indication by use of parts indicative of floors on the above-described car parts, means for alternately changing background colors, means for vertically moving parts indicative of floors on the above-described car parts, means for digitally indicating floors in car parts, and the like, and which indicates a graphical monitoring screen (refer to Patent Document 1, for example).

Patent Document 1: Japanese Patent Laid-Open No. 2003-246559

### DISCLOSURE OF THE INVENTION

### Problems to be Solved by the Invention

However, in the elevator monitoring system described in Patent Document 1, the amount of information to be indicated on the screen is large, and much time is required as the time for creating data to be indicated on a monitoring screen and the time required by an indication. For this reason, particularly in monitoring high-speed elevators, there has occurred the problem that the indication of car positions becomes discontinuous on the monitoring screen.

The present invention was made in order to solve the problem described above, and the object of the present invention is to provide an elevator monitoring system capable of preventing the indication of car positions from becoming discontinuous on a monitoring screen.

### Means for Solving the Problems

A elevator monitoring system of the present invention includes a car-position information search device which detects a car-position floor of an elevator, an indication device which indicates a symbol indicative of the car-position floor and a symbol indicative of the car so as to correspond to each other, a speed calculating device which calculates the speed of the car on the basis of a distance corresponding to a change in the car-position floor and the time required by the change, an indication unit determining device which increases the number of stories as a unit in the indication unit of the symbol indicative of the car-position floor in the case of an increase in the speed of the car, and an indication controller which causes the indication device to indicate the symbol indicative of the car-position floor by an indication unit determined by the indication unit determining device.

### ADVANTAGE OF THE INVENTION

According to the present invention, it is possible to prevent the indication of car positions from becoming discontinuous on a monitoring screen.

### BRIEF DESCRIPTION OF THE DRAWINGS

FIG. 1 is a block diagram of an elevator monitoring system in Embodiment 1 of the present invention.

FIG. 2 is a flowchart showing the operations of the elevator monitoring system in Embodiment 1 of the present invention in the calculation of the car speed.

FIG. 3 shows a first example of the screen indicated by the elevator monitoring system in Embodiment 1 of the present invention.

FIG. 4 shows a second example of the screen indicated by the elevator monitoring system in Embodiment 1 of the present invention.

FIG. 5 is a block diagram of an elevator monitoring system in Embodiment 2 of the present invention.

### DESCRIPTION OF SYMBOLS

1 elevator controller,
2 monitoring device,
3 indication device,
4 timer device,
5 car-position information search device,
6 storage device,
7 speed calculating device,
8 indication unit determining device,
9 indication controller,
10 time and date information,
11 flag information,
12 car speed,
13 indication unit information,
14 floor indication symbols,
15 car-indicating symbol,
16 count value,

### BEST METHOD FOR CARRYING OUT THE INVENTION

The best mode for carrying out the present invention will be described with reference to the accompanying drawings. Note that, in each of the drawings, like numerals refer to like or similar parts and overlaps of description of these parts are appropriately simplified or omitted.

### Embodiment 1

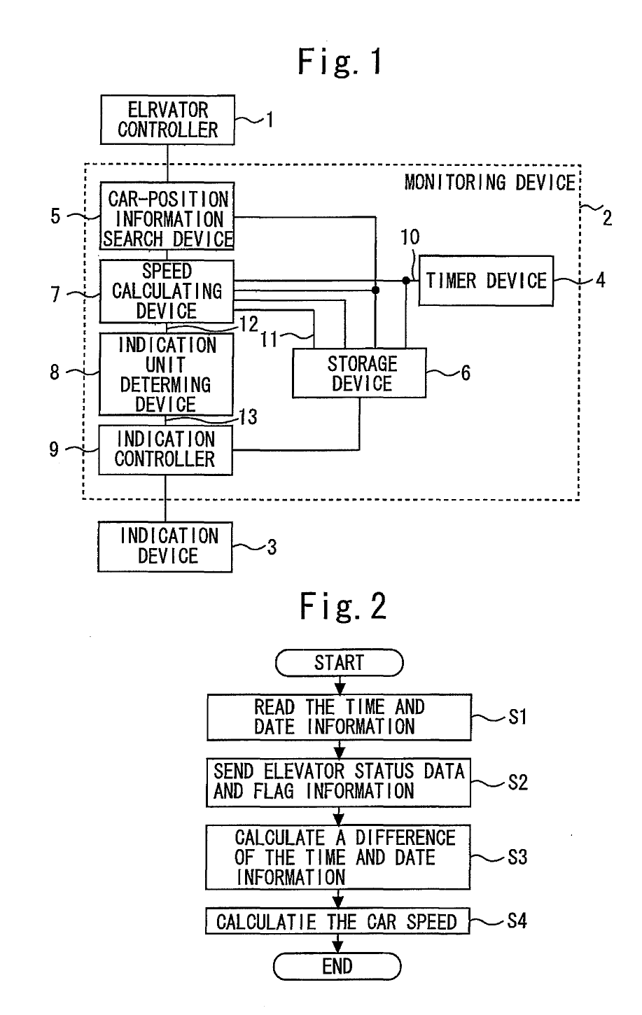

FIG. 1 is a block diagram of an elevator monitoring system in Embodiment 1 of the present invention.

In FIG. 1, reference numeral 1 denotes an elevator controller. This elevator controller 1 is provided in an elevator machine room or a shaft. Reference numeral 2 denotes a monitoring device. This monitoring device 2 is provided in a building manager room. Reference numeral 3 denotes is an indication device. Also this indication device 3 is provided in the building manager room. In an elevator monitoring system of such a configuration, the elevator controller 1 sends elevator status data. On the basis of elevator status data, the monitoring device 2 determines a method of indicating elevator status data. On the basis of the indication method determined by the monitoring device 2, the indication device 3 indicates a screen based on the elevator status data.

Next, the monitoring device 2 will be described in more detail.

The monitoring device 2 is provided with a timer device 4, a car-position information search device 5, a storage device 6, a speed calculating device 7, an indication unit determining device 8, and an indication controller 9. The timer device 4 has the function of sending time and date information 10. The car-position information search device 5 has the function of receiving elevator status data from the elevator controller 1. The car-position information search device 5 has the function of judging whether or not car-position floor information is contained in elevator status data. That is, the car-position information search device 5 has the function of detecting car-position floors.

The storage device 6 has the function of storing story height information. Story height means the height of one story corresponding to the moving distance of a car. This story height may be a fixed value, such as 4 m, for the purpose of convenience, and may also be the story height value of an actual building. The storage device 6 has the function of receiving elevator status data from the car-position information search device 5 and overwrite-saving the elevator status data when car-position floor information is not contained in the elevator status data.

The speed calculating device 7 has the function of receiving elevator status data from the car-position information search device 5 when car-position floor information is contained in the elevator status data. The speed calculating device 7 has the function of sending flag information 11 along with elevator status data to the storage device 6 upon receipt of the elevator status data. At this time, the storage device 6 receives the time and date information 10 from the timer device 4 and stores the time and date information 10 by correlating the elevator status data and the time and date information 10 to each other. That is, the storage device 6 has the function of constantly storing the newest elevator status data irrespective of whether or not car-position floor information is contained in the elevator status data.

Furthermore, the speed calculating device 7 has the function of calculating the car speed 12 on the basis of a distance corresponding to a change in car-position floor information and the time required by the change. Concretely, the speed calculating device 7 uses the story height information stored in the storage device 6 as a distance corresponding to a change in car-position floor information. Also, the speed calculating device 7 measures the time before and after a change in the car-position floor as the time required by the change in the car-position floor, and uses a difference in the time of the change.

The indication unit determining device 8 has the function of increasing the number of stories as a unit in the indication unit information 13 of floor indication symbols indicative of car-position floors when the car speed 12 has increased. Concretely, the indication unit determining device 8 compares the car speed 12 with a threshold value (TH) which is set beforehand. When the value of the car speed 12 is smaller than the threshold value (TH), the indication unit determining device 8 judges that the receiving cycle of car-position information is long and that there is a high possibility that the indication of car positions becomes continuous. In this case, the indication unit determining device 8 determines that the indication unit information 13 of symbols indicative of car-position floors refers to “one story” as a unit. On the other hand, when the value of the car speed 12 is larger than the threshold value (TH), the indication unit determining device 8 judges that the receiving cycle of car-position information is short and that there is a high possibility that the indication of car positions becomes discontinuous. In this case, the indication unit determining device 8 determines that the indication unit information 13 of symbols indicative of car-position floor refers to “two stories” as a unit.

The indication controller 9 has the function of causing, at fixed cycles, the indication device 3 to indicate floor indication symbols indicative of car-position floors by the indication unit information 13 determined by the indication unit determining device 8 and to indicate the newest elevator status data stored in the storage device 6. As a result of this, the waiting time for accepting user operations is ensured and at the same time the floor indication symbols indicative of car-position floors are indicated on the indication device 3 while they are changing dynamically.

Next, the method of calculating the car speed 12 will be described in more detail with the aid of FIG. 2.

FIG. 2 is a flowchart showing the operations of the elevator monitoring system in Embodiment 1 of the present invention in the calculation of the car speed.

First, in Step 51, the speed calculating device 7 receives elevator status data which contains at least car-position floor information from the elevator controller 1. At this time, the speed calculating device 7 reads the time and date information 10 stored in the storage device 6 and the flow of operation proceeds to Step S2. In Step S2, elevator status data and flag information 11 are sent from the speed calculating device 7 to the storage device 6 and the flow of operation proceeds to Step S3. In Step S3, after receiving present time and date information 10 from the timer device 4, the speed calculating device 7 calculates a difference between the present time and date information 10 and the read-out time and date information 10, and the flow of operation proceeds to Step S4. In Step S4, the car speed 12 is calculated by dividing story height information by the difference of the time and date information 10. For example, when story height information indicates 4 m and the difference of the time and date information 10 is 1 second, the car speed 12 is calculated to be 4 m per second.

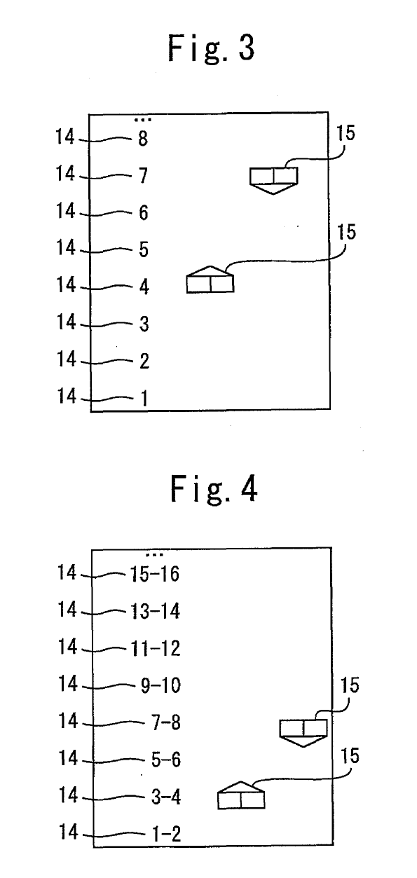

Next, the screens indicated on the indication device 3 will be described in more detail with the aid of FIGS. 3 and 4.

FIG. 3 shows a first example of the screen indicated by the elevator monitoring system in Embodiment 1 of the present invention. FIG. 4 shows a second example of the screen indicated by the elevator monitoring system in Embodiment 1 of the present invention.

In FIGS. 3 and 4, floor indication symbols 14 indicative of floors are indicated on the left side of the screen. Concretely, in FIG. 3, the floor indication symbols 14 indicative of the first floor to 8th floors are indicated vertically in a column, the indication unit being “one story”. On the other hand, in FIG. 4, the floor indication symbols 14 indicative of the first floor to 16th floors are indicated vertically in a column, the indication unit being “two stories”.

And in the middle and right side of the screen, there is indicated a car-indicating symbol 15 indicative of a car in a manner corresponding to the floor indication symbols 14 indicating the car-position floors. Concretely, in the middle of the screen, there is indicated a car-indicating symbol 15 indicative of an ascending car in a manner corresponding to the floor indication symbol 14 indicative of the 4th floor. On the right side of the screen, there is indicated a car-indicating symbol 15 indicative of a descending car in a manner corresponding to the floor indication symbol 14 indicative of the 7th floor.

According to Embodiment 1 described above, in the case of an increase in the car speed 12, an increase occurs in the number of stories as a unit in the indication unit information 13 of symbols indicative of car-position floors. For this reason, if the screen of the indication device 3 is updated by the time when the updating of elevator status data is performed multiple times, this is sufficient, whereby it becomes possible to prevent the indication of car positions from becoming discontinuous. When the value of the car speed 12 is smaller than the threshold value (TH), the indication unit of the floor indication symbol 14 becomes one story. For this reason, during a low-speed run of a car, it is possible to accurately grasp the car-position floor. Furthermore, the speed calculating device 7 measures the time before and after a change in the car-position floor and calculates the car speed 12 by regarding the difference in time before and after the change as the time required by the change. For this reason, it is possible to prevent the indication of car positions from becoming discontinuous by a simple device configuration.

### Embodiment 2

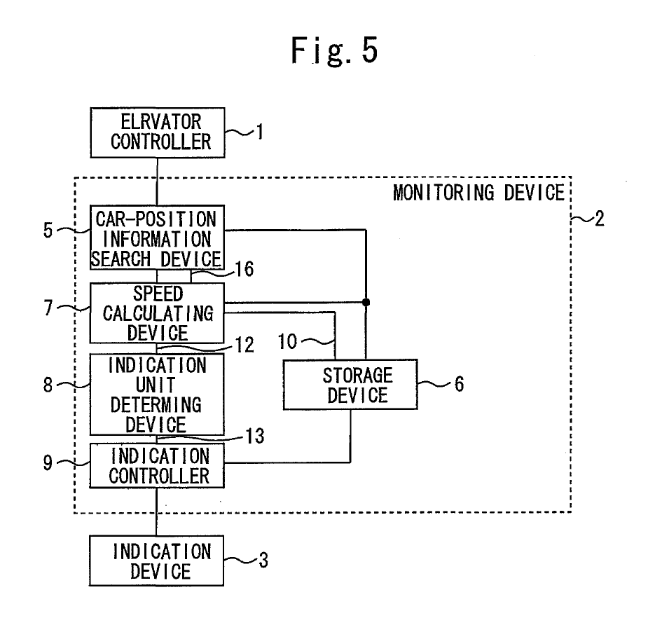

FIG. 5 is a block diagram of an elevator monitoring system in Embodiment 2 of the present invention. Like reference numbers refer to the same or corresponding parts as in Embodiment 1 and the description of such parts is omitted. The timer device 4 is provided in Embodiment 1, whereas no timer device 4 is provided in Embodiment 2.

In Embodiment 2, an elevator controller 1 sends elevator status data to a monitoring device 2 at fixed cycles. That is, a car-position information search device 5 detects car-position floor information at fixed cycles. At this time, the car-position information search device 5 counts the frequency of the detection of car-position floor information performed until a next change occurs in the car-position floor information after a change in the car-position floor information. And the car-position information search device 5 outputs a count value 16 corresponding to the frequency of detection to a speed calculating device 7 and initializes the count value 16. In this case, the speed calculating device 7 calculates the car speed 12 by regarding a product of the interval of the fixed cycles and a count value 16 as the time required by the change in the car-position floor information. Concretely, when the interval of the fixed cycles are 20 milliseconds and the count value 16 is 5, the time required by the change in the car-position floor is calculated to be 1 second.

According to Embodiment 2 described above, the time required by a change in the car-position floor is calculated by a product of the fixed cycles and the counter-indicated value 16. For this reason, the timer device 4, the storage processing of the time and date information 10 by the storage device 6, the reading processing of the time and date information 10, and the sending processing in flag information 11 processing, which are necessary in Embodiment 1, become unnecessary. That is, it is possible to prevent the indication of car positions from becoming discontinuous by a simpler device configuration.

### INDUSTRIAL APPLICABILITY

As described above, the elevator monitoring system of the present invention can be applied to elevators monitoring car-position floors.

1. An elevator monitoring system, comprising:
a car-position information search device which detects a car-position floor of an elevator;
an indication device which indicates a symbol indicative of the car-position floor and a symbol indicative of the car so as to correspond to each other;
a speed calculating device which calculates the speed of the car on the basis of a distance corresponding to a change in the car-position floor and the time required by the change;
an indication unit determining device which increases the number of stories as a unit in the indication unit of the symbol indicative of the car-position floor in the case of an increase in the speed of the car; and
an indication controller which causes the indication device to indicate the symbol indicative of the car-position floor by an indication unit determined by the indication unit determining device.

2. The elevator monitoring system according to claim 1, wherein the indication unit determining device determines that the indication unit is one story when the speed of the car is less than a threshold valve set in advance.

3. The elevator monitoring system according to claim 1, wherein the speed calculating device measures the time before and after a change in the car-position floor and calculates the speed of the car by regarding a difference in time before and after the change as the time required by the change.

4. The elevator monitoring system according to claim 1, wherein the car-position information search device detects the car-position floor at fixed cycles and
wherein the speed calculating device calculates the speed of the car by regarding a product of an interval of the fixed cycles and the frequency of the detection of the car-position floor performed until the change in the car-position floor as the time required by the change.

5. The elevator monitoring system according to claim 2, wherein the speed calculating device measures the time before and after a change in the car-position floor and calculates the speed of the car by regarding a difference in time before and after the change as the time required by the change.

6. The elevator monitoring system according to claim 2, wherein the car-position information search device detects the car-position floor at fixed cycles and
wherein the speed calculating device calculates the speed of the car by regarding a product of an interval of the fixed cycles and the frequency of the detection of the car-position floor performed until the change in the car-position floor as the time required by the change.
